(19) United States
(12) Patent Application Publication
(10) Pub. No.: US 2013/0003261 A1
(43) Pub. Date: Jan. 3, 2013

(54) LITHIUM PLATE, METHOD FOR LITHIATION OF ELECTRODE AND ENERGY STORAGE DEVICE

(75) Inventors: Sergey Remizov, Gyeonggi-do (KR); Hong Seok Min, Gyeonggi-do (KR); Bae Kyun Kim, Gyeonggi-do (KR); Hyun Chul Jung, Gyeonggi-do (KR)

(73) Assignee: SAMSUNG ELECTRO-MECHANICS CO., LTD., Suwon (KR)

(21) Appl. No.: 13/533,111

(22) Filed: Jun. 26, 2012

(30) Foreign Application Priority Data
Jun. 30, 2011 (KR) 10-2011-0065186

(51) Int. Cl. C25D 17/12; H01G 9/025; C25D 7/00

(52) U.S. Cl. 361/527; 205/57; 204/284

(57) ABSTRACT

Disclosed herein are a lithium plate, a method for lithiation of an electrode, and an energy storage device. According to an exemplary embodiment of the present invention, there is provided a lithium plate used for lithium pre-doping of an electrode for an energy storage device, including: a contact area contacting the electrode at the time of the pre-doping; and a plurality of through holes or a plurality of grooves regularly distributed to be adjacent to the contact area so that an electrolytic solution gains easy access to the vicinity of a contact boundary of the contact area and the electrode at the time of the pre-doping. In addition, a method for lithiation of an electrode for an energy storage device using the above-mentioned lithium plate and an energy storage device including a negative electrode (anode) lithiated according to the method have been proposed.

### CROSS REFERENCE(S) TO RELATED APPLICATIONS

This application claims the benefit under 35 U.S.C. Section 119 of Korean Patent Application Serial No. 10-2011-0065186, entitled “Lithium Plate, Method for Lithiation of Electrode and Energy Storage Device” filed on Jun. 30, 2011, which is hereby incorporated by reference in its entirety into this application.

### BACKGROUND OF THE INVENTION

1. Technical Field

The present invention relates to a lithium plate, a method for lithiation of an electrode, and an energy storage device. More particularly, the present invention relates to a lithium plate for improving uniformity and rate of pre-doping of an electrode for an energy storage device, a method for lithiation for an electrode for an energy storage device using the lithium plate, and an energy storage device having a negative electrode lithiated according to the method for lithiation.

2. Description of the Related Art

A stable supply of energy is an important factor in various electronic products or electronic devices. Generally, the function of stably supplying energy is performed by an energy storage device such as a capacitor. Recently, various types of electrochemical capacitors have been developed. Among others, an energy storage device called a hybrid capacitor manufactured using storage principles of a lithium ion secondary battery and an electric double layer capacitor has been in the limelight.

Among hybrid electrochemical capacitors, recently lithium-ion capacitors have attracted considerable industrial interest. As compared with lithium-ion batteries, lithium-ion capacitors demonstrate much higher power capability and much longer cycle life. The lithium ion capacitors offer a significant energy density enhancement with respect to electrical double layer capacitors (EDLC), which have been used for high energy boost applications for several decades. The merit of the high energy density is due to the fact that the lithium ion capacitor can be operated at higher operating voltage, while the energy density scales with a square of voltage.

A positive electrode (cathode) for the lithium ion capacitor has characteristics of non-faradic adsorption and desorption of ions from an organic electrolyte. A cathode material specially has a very developed surface area due to a plurality of micro-pores, meso-pores and macro-pores, and therefore is capable to reversibly store and release a large amount of charges in a short time.

The high operating voltage of lithium-ion capacitor is achieved primarily because the negative electrode of the capacitor is made of the material having very low potential with respect to the cathode. The negative electrode (anode) for the lithium ion capacitor is typically made of a carbonaceous material having substantially smaller porosity. The lowering of the potential of the carbonaceous material is achieved as a result of electrochemical insertion of lithium ions into the structure of carbon according to the following reaction scheme.

C+xLi⁺+xe⁻→LiₓC

For example, lithium ions may be electrochemically inserted between graphene surfaces of graphite. Consequently, the process (referred to as intercalation in the case of the graphite) eventually results in the formation of LiC₆ compound. Depending upon type of a carbon used, the amount of lithium, which can be reversibly stored during that process, may vary significantly.

In what follows, an operation of lowering the potential of the anode of the energy storage device based on the above-mentioned reaction with participation of lithium ions is referred to as lithium pre-doping.

Various methods of lithium pre-doping have been known to in the art. U.S. Pat. No. 5,743,921 discloses a pre-lithiation method. In this document, the carbon is cathodized under constant current opposite to a lithium metal counter electrode in a non-aqueous lithium conducting solution so as to electrolytically deposit enough lithium into a said carbon to deactivate any active sites in the carbon, yet leave said carbon with sufficient residual lithium capacity.

US Patent Application Publication No. 2010/0255356A1 discloses a lithium ion energy storage device, in particular, a lithium ion capacitor. In this document, pre-lithiation (referred to as “pre-doping”) is made by short-circuiting of the lithium metal electrode with current collectors of negative electrodes and lithium ions (Li⁺) move through the permeable porous structures of current collectors, electrodes and separators before reaching the carbon anodes and doping the carbon with lithium ions (Li⁺).

However, the proposed methods has a drawback in that the rate of pre-doping is different for the carbon electrodes positioned closer to the lithium metal and for those electrodes positioned apart from the lithium metal electrode In particular, in case of the negative electrode positioned apart from the lithium metal, the potential drop rate is small.

US Patent Application Publication No. 2009/0148773A1 discloses a method for manufacturing a negative electrode for a lithium ion battery, which comprises the steps of contacting tightly the carbonaceous material with the piece of lithium metal, storing the carbonaceous material and the piece of lithium metal in the atmosphere and optionally, in electrolyte, for a period of time sufficient to completely lithiate the carbonaceous material. Employing wetting step (after and/or during the application of pressure) allows lithiation process to proceed at a much faster rate than in a dry condition. Without being bound or limited by any particular theory, it is believed that this phenomenon occurs by functioning of a short-circuited galvanic pair “lithium-carbon” in the presence of the non-aqueous electrolyte. It is also believed that in the case of wetting, lithium intercalation takes place over a majority, if not an entirety, of a wetted surface of carbonaceous material, whereas in the dry condition this process takes place only in contact points between the carbonaceous material and the piece of lithium metal.

U.S. Pat. No. 6,761,744B1 discloses a technology of lithiation through lamination of lithium thin film on electrode to increase battery capacity consisting of depositing lithium onto a plastic carrier and hot-pressing the coated electrode material and the lithium-deposited plastic between two rollers or two plates.

FIG. 8 schematically shows an insertion of lithium ions into carbon contacting a lithium metal in an electrolyte. FIG. 8 shows a lithiation mechanism described in the above US Patent Application Publication No. US2009/0148773A1. The mechanism is similar to galvanic corrosion in a short-circuited lithium/carbon couple brought into the contact with lithium ion conducting electrolyte solution. The lithium metal having low potential is oxidized. The lithium ions generated by the oxidation are transferred to carbon through the electrolyte and electrons generated by the oxidation are transferred to graphene surfaces of carbon through a direct contact area. The reduction occurs according to above-written reaction, which leads to the insertion of lithium ions into carbon and the formation of LiₓC₆.

FIGS. 9A and 9B schematically show a contact between lithium and a carbon electrode in a method for lithiation of an electrode according to the related art. FIGS. 9A and 9B show a state in which a carbon electrode and a lithium metal are immersed in an electrolyte or wetted by the electrolyte after being compressed to each other.

FIG. 9A shows the case of a weak compression, so that a sufficient amount of electrolyte can penetrate into the voids remained between lithium and carbon. The surfaces of carbon and lithium are not ideally smooth and flat, but rather have irregular roughness and/or waviness. Therefore, the number of contact points between lithium metal and carbon surface is relatively small and contact points are non-uniformly distributed over the area between lithium metal and carbon electrode. This will cause non-uniform lithiation of the carbon electrode.

FIG. 9B shows the case, when compression was strong enough to cause intimate contact between the carbon and lithium, resulting in the drastic reduction or total elimination of the voids between these electrodes. In this case, electrolyte cannot penetrate into the spaces remained between lithium and carbon, or its penetration is significantly hampered, so that efficient functioning of the galvanic corrosion couple, depicted in FIG. 8 and resulting lithiation becomes difficult.

### SUMMARY OF THE INVENTION

An object of the present invention is to improve uniformity and rate of pre-lithiation of an energy storage device, in particular, an electrode used for a lithium ion capacitor, preferably, a carbon anode electrode.

By the analysis of the above-mentioned problem, the present invention is to implement a rapid and uniform lithiation process. To achieve this, an object of the present invention is to provide a lithium plate having a special structure satisfying conditions in which first, a plurality of uniformly distributed contact points are provided between carbon and lithium metal and second, an electrolytic solution (electrolyte) easily accesses an area around contact points, a method for lithiation of an electrode using the lithium plate, and an energy storage device having high efficiency obtained through the uniform lithiation.

According to an exemplary embodiment of the present invention, there is provided a lithium plate used for lithium pre-doping of an electrode for an energy storage device, including: a contact area contacting the electrode at the time of the pre-doping; and a plurality of through holes regularly distributed to be adjacent to the contact area so that an electrolytic solution gains easy access to the vicinity of a contact boundary of the contact area and the electrode at the time of the pre-doping.

A ratio of a width of the contact area between two through holes to a width of the through hole may be in a range of approximately 0.5 to 2.0.

The through holes may have a circular shape or a regular polygonal shape.

The width of the through hole may be in a range of approximately 10 to 10,000 μm.

The lithium plate may be reused for the pre-doping.

According to another exemplary embodiment of the present invention, there is provided a lithium plate used for lithium pre-doping of an electrode for an energy storage device, including: a plurality of contact areas contacting the electrode at the time of the pre-doping; and a plurality of grooves regularly distributed to be adjacent to the contact area so that an electrolytic solution gains easy access to the vicinity of contact boundaries of the contact areas and the electrode at the time of the pre-doping.

The plurality of grooves may be arranged in a 1-direction.

The plurality of grooves may be arranged in a 2-direction so as to cross each other, and the plurality of contact areas may be island areas formed by the plurality of grooves.

A top surface and a bottom surface of the lithium plate may be provided with the plurality of grooves and the plurality of contact areas.

A ratio of a width of the contact area between the grooves to a width of the groove may be in a range of approximately 0.5 to 2.0.

A cross section of the groove may be a ‘U’-letter shape, a rectangular shape, a triangular shape, or a trapezoidal shape.

A top width of the groove may be in a range of approximately 10 to 10,000 μm.

The lithium plate may be reused for the pre-doping.

According to another exemplary embodiment of the present invention, there is provided a method for lithiation of an electrode for an energy storage device, including: preparing the lithium plate according to the above-mentioned embodiments; stacking the lithium plate on an electrode material layer formed on a current collector; and immersing the stacked structure in an electrolyte and pre-doping lithium ions on the electrode material layer.

The energy storage device may be a lithium ion capacitor.

The electrode may be a negative electrode (anode).

The electrode material layer formed on the current collector may be formed by coating and drying a mixing slurry of an active material, conductive additives, and a binder on the current collector, and at the stacking of the lithium plate, the lithium plate may be stacked on the electrode material layer by being compressed.

The active material may be carbon.

The electrolyte may be an aprotic organic electrolyte including a lithium salt.

The electrode material layer may be a carbonaceous electrode layer, and at the pre-doping, an amount of the pre-doped lithium may be in a range of approximately 0.05 to 1 of a weight of the carbonaceous electrode.

At the preparing of the lithium plate, a plurality of lithium plates in which both surfaces of the top and bottom thereof may be provided with the plurality of grooves and the plurality of contact areas are prepared, and at the stacking of the lithium plate, a laminated structure may be formed by stacking the plurality of electrode material structures between the plurality of lithium plates, wherein the electrode material structure has the electrode material layers formed on both surfaces of the top and bottom of the current collector.

According to another exemplary embodiment of the present invention, there is provided an energy storage device, including: the carbonaceous negative electrode (anode) uniformly lithiated as described above; a porous carbonaceous positive electrode (cathode) reversibly inputting and discharging lithium ions; a separator separating the negative electrode and the positive electrode; and an organic electrolyte electrochemically communicating with the negative electrode and the positive electrode.

The energy storage device may be a lithium ion capacitor.

### BRIEF DESCRIPTION OF THE DRAWINGS

FIG. 1 is a diagram schematically showing a lithium plate according to an exemplary embodiment of the present invention.

FIGS. 2A to 2D each are diagrams schematically showing a lithium plate according to another exemplary embodiment of the present invention.

FIG. 3 is a diagram schematically showing a structure in which the lithium plate shown in FIG. 1 is stacked on an electrode.

FIG. 4 is a diagram schematically showing a structure in which the lithium plate shown in FIG. 1 is stacked on the electrode according to a method for lithiation of an electrode according to another exemplary embodiment of the present invention.

FIGS. 5A to 5C each are diagrams schematically showing a structure in which the lithium plate shown in FIG. 1 is stacked on the electrode according to the method for lithiation of an electrode according to the exemplary embodiment of the present invention.

FIG. 6 is a diagram schematically showing a structure in which the lithium plate shown in FIG. 2D is stacked on the electrode according to the method for lithiation of an electrode according to the exemplary embodiment of the present invention.

FIGS. 7A and 7B each are flow charts schematically showing a method for lithiation of an electrode according to another exemplary embodiment of the present invention.

FIG. 8 is a diagram schematically showing an insertion of lithium ions into carbon contacting a lithium metal in an electrolyte.

FIGS. 9A and 9B are diagrams schematically showing a contact between lithium and a carbon electrode in a method for lithiation of an electrode according to the related art.

### DESCRIPTION OF THE PREFERRED EMBODIMENTS

Exemplary embodiments of the present invention for accomplishing the above-mentioned objects will be described with reference to the accompanying drawings. In describing exemplary embodiments of the present invention, the same reference numerals will be used to describe the same components and an additional description that is overlapped or allow the meaning of the present invention to be restrictively interpreted will be omitted.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween.

Although a singular form is used in the present description, it may include a plural form as long as it is opposite to the concept of the present invention and is not contradictory in view of interpretation or is used as clearly different meaning. It should be understood that “include”, “have”, “comprise”, “be configured to include”, and the like, used in the present description do not exclude presence or addition of one or more other characteristic, component, or a combination thereof.

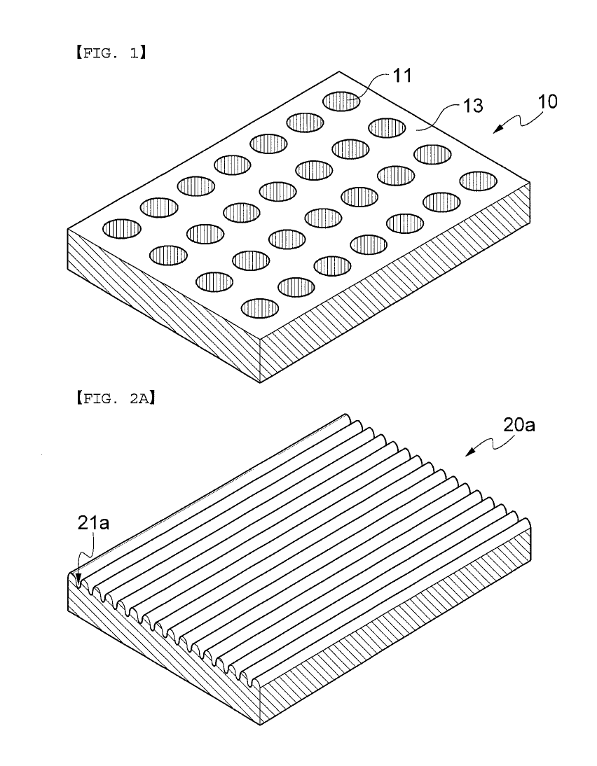

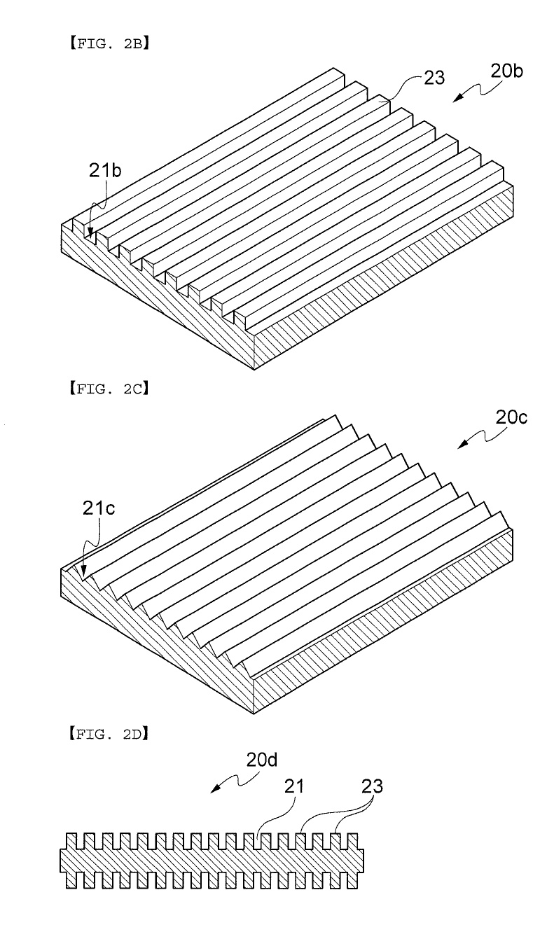

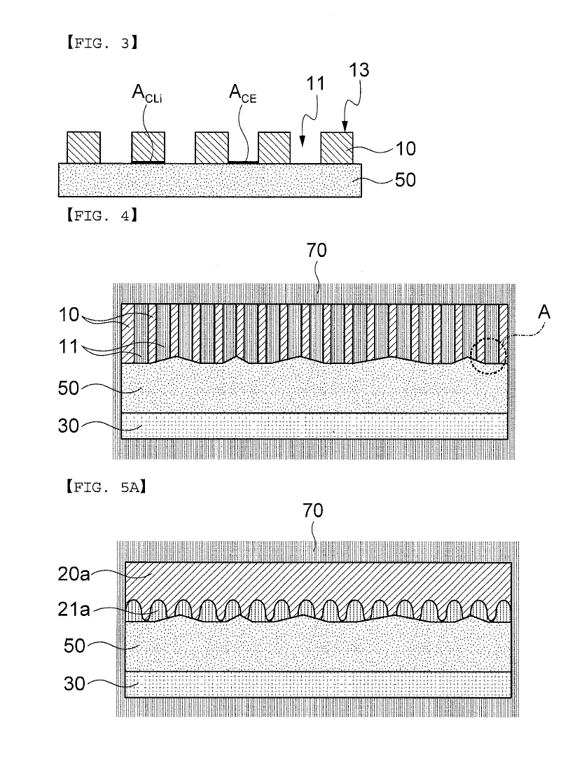

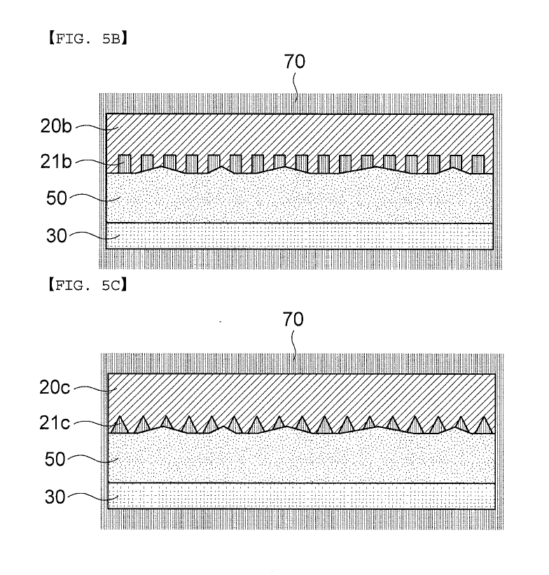

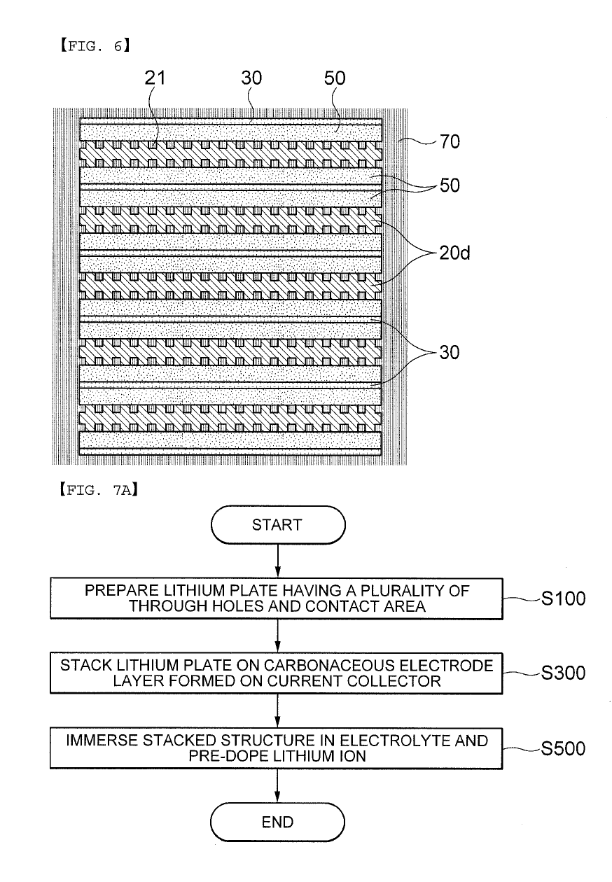

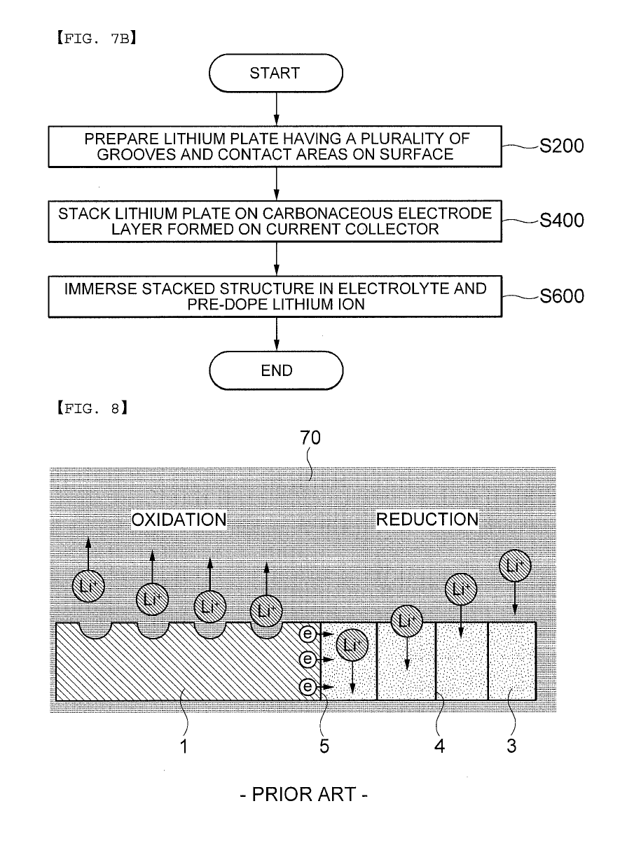

FIG. 1 schematically shows a lithium plate according to an exemplary embodiment of the present invention. FIGS. 2A to 2D each schematically show a lithium plate according to another exemplary embodiment of the present invention. FIG. 3 schematically shows a structure in which the lithium plate shown in FIG. 1 is stacked on an electrode. FIG. 4 schematically shows a structure in which the lithium plate shown in FIG. 1 is stacked on the electrode according to a method for lithiation of an electrode according to another exemplary embodiment of the present invention. FIGS. 5A to 5C each schematically shows a structure in which the lithium plate shown in FIG. 1 is stacked on the electrode according to the method for lithiation of an electrode according to the exemplary embodiment of the present invention. FIG. 6 schematically shows a structure in which the lithium plate shown in FIG. 2D is stacked on the electrode according to the method for lithiation of an electrode according to the exemplary embodiment of the present invention. FIGS. 7A to 7B each show flow charts schematically showing a method for lithiation of an electrode according to another exemplary embodiment of the present invention.

First, a lithium plate according to exemplary embodiments of the present invention will be described in detail with reference to FIGS. 1 to 3. A lithium plate 10 according to an exemplary embodiment of the present invention is used for lithium pre-doping of an electrode for an energy storage device.

Herein, the electrode for the energy storage device is preferably a negative electrode (anode) and more preferably a carbonaceous electrode. In addition, the energy storage device is an energy storage device that performs charging and discharging by electrochemically communicating with lithium ions between the anode electrode and a cathode electrode. For example, the energy storage device is a lithium ion capacitor.

Referring to FIGS. 1 or/and 3, the lithium plate 10 according to an exemplary embodiment of the present invention is configured to include a contact area 13 and a plurality of through holes 11. In this configuration, the contact area 13 is an area contacting the electrode (see reference numeral 50 of FIG. 4) of the energy storage device when pre-doping the lithium ions. In addition, the plurality of through holes 11 are formed to easily access an electrolytic solution (see reference numeral 70 of FIG. 4) around contact boundaries between the contact areas 13 and the electrode 50 when pre-doping the lithium ions. The plurality of through holes 11 are adjacent to the contact areas 13 and regularly distributed between the contact areas 13. In this case, referring to FIG. 4, the plurality of through holes 11 form a plurality of triple contact points A among the lithium metal, the electrode 50, and the electrolytic solution 70.

When pre-doping the lithium of the electrode 50 of the energy storage device through the plurality of through holes 11 that are regularly distributed according to the exemplary embodiment of the present invention, the electrolytic solution 70 or an electrolyte may be smoothly supplied around the contact boundary between the contact area 13 and the electrode 50 of the lithium plate 10, thereby uniformly and rapidly pre-doping the lithium ions.

The exemplary embodiment of the present invention will be described with reference to FIG. 3. Referring to FIG. 3, a ratio of a width A_{CLI} of the contact area 13 between two through holes 11 to a width A_{CE} of the through hole 11 may be in a range of approximately 0.5 to 2.0. Since the doping in an electrode thickness direction of Li indicates an isotropic direction, the ratio of the width A_{CLI} of the contact area 13 between two through holes 11 to the width A_{CE} of the through hole 11 may be maintained to be the range of approximately 0.5 to 2.0. The width A_{CLI} of the contact area 13 between the substantial through holes 11 has been affected by the electrode 50 to be doped, preferably, the thickness of the negative electrode.

In addition, according to another exemplary embodiment of the present invention, the through hole 11 may have various shapes, preferably, a circular shape shown in FIG. 1 or a regular polygonal shape (not shown). The regular polygon may be a regular squared shape, a regular hexagonal shape, a regular octagonal shape, or the like, but may also be a regular triangular shape, a regular pentagonal shape, or the like. The though hole 11 may be generated by appropriate methods such as mechanical drilling, punching, laser drilling, or the like.

In addition, according to another exemplary embodiment of the present invention, the width of the through hole 11 may be in a range of approximately 10 to 10,000 μm. In FIG. 3, A_{CE} shows the width of the through hole 11. For example, when the through hole 11 is a circle, the width A_{CE} means a diameter, when the through hole 11 is a regular polygonal shape, the width A_{CE} means a distance between two sides facing each other, in particular, a distance from one apex to sides facing each other when two sides facing each other are not present.

In addition, according to one characteristic of the exemplary embodiment of the present invention, the lithium plate 10 may be reused for the pre-doping of the electrode 50. The reuse is one of the important characteristics of the exemplary embodiment of the present invention. Compared with the mesh structure according to the related art, the characteristics of the exemplary embodiment of the present invention may be easily understood. When using mesh lithium according to the related art, it is difficult to reuse the mesh lithium when considering a mesh structure, once doping is performed. The reason is that the mesh structure does not have a stiff membrane. When a diameter of the mesh wire extends in order to increase stiffness in the existing mesh structure, the contact area with the electrode to be doped is small and thus, the doping efficiency is degraded. As a result, in the related art having the existing mesh structure, the doping may be substantially performed only once, while in the present invention, the lithium plate may be reused for the doping, which is a difference between the related art and the present invention. In particular, in the exemplary embodiment of the present invention, the lithium plate 10 having the structure of the though hole 11 has a predetermined thickness or more so as to have stiffness. The structure of the through hole 11 itself does not limit the thickness of the lithium plate 10 and thus, may be reused unlike the mesh structure. Therefore, it is possible to obtain the multi-usable lithium plate 10 capable of being applied to a lithium doping process for mass production.

Next, a lithium plate according to another exemplary embodiment of the present invention will be described with reference to FIGS. 2A to 2D.

Referring to FIGS. 2A to 2D, lithium plates 20a, 20b, 20c, and/or 20d according to the exemplary embodiment of the present invention are configured to include a plurality of contact areas (see reference numeral 23 shown in FIG. 2B) and a plurality of grooves 21, 21a, 21b, and/or 21c. In this configuration, the plurality of contact areas 23 contact the electrode (see reference numeral 50 of FIGS. 5A to 5C and FIG. 6) when pre-doping the lithium of the electrode of the energy storage device. In addition, the plurality of grooves 21, 21a, 21b, and/or 21c are formed to easily access an electrolytic solution (see reference numeral 70 of FIGS. 5A to 5C and FIG. 6) around the contact boundaries of the contact areas 23 and the electrode 50 when pre-doping the lithium ions. The plurality of grooves 21, 21a, 21b, and/or 21c are adjacent to the plurality of contact areas 23 and are regularly distributed between the contact areas 23. The plurality of grooves 21, 21a, 21b, and/or 21c form channels through which the electrolyte 70 flows, thereby forming the plurality of triple contact points among the lithium metal, the electrode 50, and the electrolytic solution 70.

When pre-doping the lithium of the electrode 50 of the energy storage device through the plurality of grooves 21, 21a, 21b, and/or 21c that are regularly distributed according to the exemplary embodiment of the present invention, the electrolytic solution 70 or the electrolyte may be smoothly supplied around the contact boundaries between the contact areas 23 and the electrodes 50 of the lithium plates 20a, 20b, 20c, and/or 20d, thereby uniformly and rapidly pre-doping the lithium ions.

The lithium plates 20a, 20b, 20c, and/or 20d having the grooves 21, 21a, 21b, and/or 21c according to the exemplary embodiment of the present invention more smoothly move the electrolytic solution than the mesh structure in the related art. For example, as shown in FIG. 6, when doping several sheets of electrodes, for example, the negative electrode in a sandwich stacked structure, the lithium plate or a lithium foil and the electrode are stacked and then, are closely adhered to each other for forming a contact, such that the electrolytic solution flowing in between the interface of the electrode and the lithium plate (or lithium foil) may be changed according to what structure the lithium plate or the lithium foil has. That is, when a lithium foil has the mesh structure according to the related art, the mesh structured lithium foil has a form in which the electrolyte is trapped in the mesh inner space formed by being closely adhered between the electrode and the lithium. On the other hand, in the lithium plates 20a, 20b, 20c, and/or 20d having the structure of the grooves 21, 21a, 21b, and/or 21c according to the exemplary embodiment of the present invention, the space formed by being closely adhered between the electrode 50 and the lithium forms a channel connected to the outside, such that the electrolyte may not be trapped therein and may easily be discharged or supplied from or to the outside through the channel groove. Since the smooth supply or distribution of the electrolyte is a very important factor in the doping, the lithium plates 20a, 20b, 20c, and/or 20d having the groove structure according to the exemplary embodiment of the present invention is very excellent in terms of uniformity or efficiency of pre-doping.

Describing another exemplary embodiment of the present invention with reference to FIGS. 2A to 2C, the plurality of grooves 21, 21a, 21b, and/or 21c are arranged in 1-direction.

Although not shown, according to another exemplary embodiment, the plurality of grooves are arranged in 2-direction to cross each other. In this case, a plurality of island areas formed by the plurality of grooves are the contact areas contacting the electrode.

In addition, the exemplary embodiment of the present invention will be described with reference to FIG. 2D. Referring to FIG. 2D, the plurality of grooves 21 and the plurality of contact areas 23 are formed on a top surface and a bottom surface of the lithium plate 20d. In this configuration, the plurality of grooves 21 may be a quadrangular shape as shown in FIG. 2D or may be a ‘U’-letter shape, a triangular shape as shown in FIGS. 2A and 2C. Although not shown, the plurality of grooves 21 may have other various shapes.

In addition, describing the exemplary embodiment of the present invention with reference to FIGS. 2A to 2D, a cross section of the grooves 21, 21a, 21b, and/or 21c may have a ‘U’-letter shape as shown in FIG. 2A, a rectangular shape as shown in FIG. 2B, and a triangular shape as shown in FIG. 2C or although not shown, may have various shapes such as a trapezoid, or the like. The shape of the grooves 21, 21a, 21b, and/or 21c may be disposed on the lithium plates 20a, 20b, 20c, and/or 20d by mechanical grooving, embossing, or other appropriate methods. In FIGS. 2A to 2D, the cross section structure of the plurality of grooves 21, 21a, 21b, and/or 21c and the contact areas (see reference numeral 23 of FIGS. 2B and 2D) on the lithium plates 20a, 20b, 20c, and/or 20d are shown in a sine wave shape, a square wave shape, and a triangular wave shape. However, even when the cross section of the grooves 21a and/or 21c is the ‘U’-letter shape or/and the triangular shape as shown in FIGS. 2A or/and 2C, the top of the contact area protruded so as for the contact area to have a predetermined area may be configured in a quadrangular shape, trapezoidal shape, or the like. In addition, in FIGS. 2A or/and 2C, a cross section structure of the plurality of grooves 21a and/or 21c and the contact area are shown in a sine wave shape, a triangular wave shape. In this case, the contact area is understood as an area substantially having a predetermined width rather than a line shape. In addition, the lithium plates 20a and 20c of FIGS. 2A or/and 2C is compressed to the electrode 50 at the time of the pre-doping as shown in FIGS. 5A or/and 5C even when the contact area is formed to approximate the line shape and thus, has a predetermined contact area between the lithium plates 20a and/or 20c and the electrode 50.

Describing the exemplary embodiment of the present invention, a ratio of a width of the contact area between the grooves to a width of the grooves 21, 21a, 21b, and/or 21c is in a range of approximately 0.5 to 2.0. Since the doping in the electrode thickness direction of Li indicates an isotropic direction, the ratio of the width of the contact area between the grooves to the width of the grooves 21, 21a, 21b, and/or 21c may be maintained to be in the range of approximately 0.5 to 2.0. The substantial width of the contact area between the grooves is affected by the electrode 50 to be doped, preferably, the thickness of the negative electrode.

In addition, according to the exemplary embodiment of the present invention, a top width of the grooves 21, 21a, 21b, and/or 21c is in a range of approximately 10 to 10,000 μm.

In addition, according to another exemplary embodiment of the present invention, the lithium plates 20a, 20b, 20c, and/or 20d can be reused for pre-doping. Compared with the mesh structure according to the related art, the characteristics of the exemplary embodiment of the present invention may be easily understood. When using the mesh lithium according to the related art, since the mesh structure does not have a stiff membrane, it is difficult to reuse the mesh lithium, once the doping is performed. When a diameter of the mesh wire extends in order to increase stiffness in the existing mesh structure, the contact area with the electrode to be doped is small and thus, the doping efficiency is degraded. On the other hand, according to the exemplary embodiment of the present invention, the lithium plates 20a, 20b, 20c, and/or 20d having the structure of the grooves 21, 21a, 21b, and/or 21c have a predetermined thickness or more so as to have stiffness. Since the structure of the groove 21, 21a, 21b, and/or 21c itself does not limit the thickness of the lithium plates 20a, 20b, 20c, and/or 20d, and thus, may be reused unlike the mesh structure. Therefore, it is possible to obtain the multi-usable lithium plates 20a, 20b, 20c, and/or 20d capable of being applied to a lithium doping process for mass production.

Next, the exemplary embodiments of a method for lithiation of an electrode for an energy storage device according to another exemplary embodiment of the present invention will be described with reference to FIGS. 4, 5A to 5C, 6, 7A, and 7B. In the exemplary embodiment, the configuration of the lithium plate will be described with reference to FIGS. 1 to 3.

Referring to FIGS. 7A and 7B, the method for lithiation of the electrode 50 according to the exemplary embodiment of the present invention includes preparing the lithium plate (S100 and S200), stacking the lithium plate (S300), and pre-doping (S500). At the preparing of the lithium plate (S100 and S200), any one of the lithium plates 10, 20a, 20b, 20c, and/or 20d according to the exemplary embodiment of the present invention is prepared. FIGS. 4 and 7A show that the lithium plate 10 having the plurality of through holes 11 is prepared and FIGS. 5A to 5C, 6, and 7B show that the lithium plates 20a, 20b, 20c, and/or 20d having the plurality of grooves 21, 21a, 21b, and/or 21c are prepared.

Next, at the stacking of the lithium plate (S300), the lithium plates 10, 20a, 20b, 20c, and/or 20d are stacked on the electrode material layer (50) formed on a current collector 30. In one example, the current collector 30 is a copper current collector.

Further, at the pre-doping (S500), the stacked structure at the stacking of the lithium plate is immersed into the electrolyte as shown in FIGS. 4, 5A to 5C, and 6 to pre-dope the lithium ions on the electrode material layer (50). In one example, after the time sufficiently preset for complete lithiation lapses, the electrochemical cell, for example, the lithium ion capacitor in the stacked structure, for example, the stack of the electrodes is taken out from an immersion tank and the electrodes are dried, which are used to form an electrochemical cell, for example, a lithium ion capacitor.

The electrolytic solution 70 or the electrolyte may be smoothly supplied around the contact boundaries of the contact areas 23 and the electrodes 50 on the lithium plates 10, 20a, 20b, 20c, and/or 20d through the plurality of through holes 11 or the plurality of grooves 21, 21a, 21b, and/or 21c by performing the pre-doping while having any one of the lithium plates 10, 20a, 20b, 20c, and/or 20d according to the exemplary embodiment of the present invention, thereby uniformly and rapidly pre-doping the lithium ions.

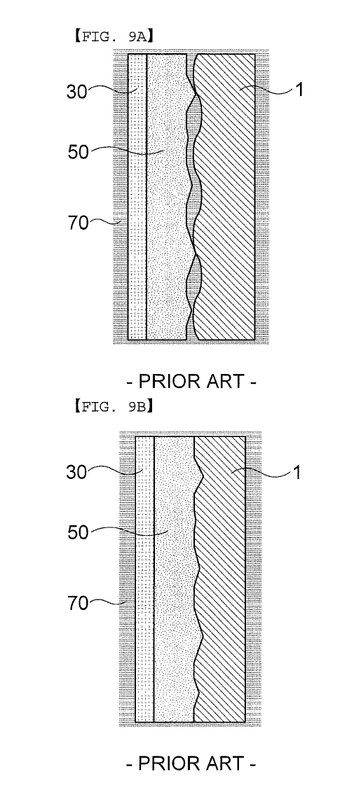

For example, as shown in FIG. 4, the electrolytic solution or the electrolyte 70 may be easily permeated so as to reach the surface of the electrode 50, for example, the carbonaceous electrode through the plurality of through holes 11 on the lithium plate 10. Therefore, the plurality of areas A in which a triple contact of “lithium-active material (for example, carbon)—electrolyte” is performed are generated over the surface of the electrode. The areas in which the triple contact of the “lithium-active material (for example, carbon)—electrolyte” is performed serve as galvanic couples so as to reach the electrode 50, for example, the lithiation of the carbon electrode. The rate of the lithiation process is much faster than the case shown in FIG. 9B of the related art due to the easy access of the electrolytic solution 70.

Preferably, a weight of the lithium plates 10, 20a, 20b, 20c, and/or 20d stacked on the electrode 50 material layer, which is consumed during the pre-lithiation, i.e., the pre-doping process, depends on the electrode 50 treated for lithiation, for example, the form of the carbon electrode. In particular, the consumed weight of lithium returns to the electrolytic solution 70 as lithium ions (Li⁺) during the subsequent discharging, which is equal to a sum of a weight of reversibly consumed lithium that can be discharged and, for example, a weight of lithium irreversibly consumed during the increase in a so-called solid-electrolyte interface (SEI) or irreversibly trapped by a predetermined other methods. Therefore, an amount of the lithium metal treated for lithiation may be defined using, a value of the first insertion capacity of the electrode 50, for example, a special carbon electrode. Therefore, the amount of lithium treated for lithiation may be changed from approximately 0.05 to approximately 1.0 of the weight of the electrode 50, for example, the carbon electrode.

In addition, in the exemplary embodiment of the present invention, the number of through holes 11 per one unit area of the lithium plate 10 depends on the electrode 50, for example, the form of the carbon electrode, the size of the through hole 11, the thickness of the lithium plate 10, or the like. Preferably, the number of through holes 11 per one unit area of the lithium plate 10 provided during the preparing of the lithium plate may be easily optimized to obtain the expected lithiation results (for example, the open circuit potential of the carbon electrode has a range of 0 to 0.1 V for Li/Li⁺ after the lithium consumption).

In addition, as shown in FIGS. 5A to 5C and/or FIG. 6, when the lithium plate is stacked (or compressed) on the electrode 50 material layer of the lithium foils 20a, 20b, 20c, and/or 20d including the plurality of grooves 21, 21a, 21b, and/or 21c and immersed in the electrolytic solution 70, the plurality of grooves 21, 21a, 21b, and/or 21c form the channel so that the electrolytic solution 70 may be easily permeated so as to wet the “lithium-electrode (for example, carbon electrode)” galvanic couple. In the exemplary embodiment of the present invention, the channel formed by the plurality of grooves 21, 21a, 21b, and/or 21c for rapidly lithiating the electrode 50, for example, the carbon electrode is required.

Preferably, the energy storage device according to the exemplary embodiment of the present invention is an energy storage device that performs charging and discharging by electrochemically communicating with the lithium ions. For example, the energy storage device is the lithium ion capacitor.

Preferably, in the exemplary embodiment of the present invention, the electrode 50 pre-doped with the lithium ions is the negative electrode (anode) 50. More preferably, the electrode 50 is a carbonaceous electrode.

Further, describing another exemplary embodiment of the present invention, the electrode 50 material layer formed on the current collector 30 is formed by coating and drying a mixing slurry of an active material, conductive additives, and a binder on the current collector 30. Preferably, the active material is carbon, by way of example.

In addition, at the stacking of the lithium plates 10, 20a, 20b, 20c, and/or 20d, the lithium plates 10, 20a, 20b, 20c, and/or 20d are stacked on the electrode 50 material layer by being compressed. Preferably, the lithium plates are stacked by thermo compression.

Further, according to another exemplary embodiment of the present invention, the electrolytic solution or the electrolyte 70 is an aprotic organic electrolyte including a lithium salt.

According to another exemplary embodiment of the present method invention, the amount of lithium pre-doped during the pre-doping of the lithium (S500) is in a range of approximately 0.05 to 1 of the weight of the carbonaceous electrode 50.

Further, another exemplary embodiment of the present method invention will be described with reference to FIG. 6.

At the preparing of the lithium plate according the exemplary embodiment of the present invention, the plurality of lithium plates 20d in which both surfaces of the top and bottom thereof are provided with the plurality of grooves 21 and the plurality of contact areas 23 are prepared. Further, at the stacking of the lithium plate 20d, a laminated structure is formed by stacking the plurality of electrode 50 material structures formed on the electrode 50 material layer on both surfaces of the top and bottom of the current collector 30 between the plurality of lithium plates 20d. In this case, the electrode 50 material structure in which the electrode 50 material layer is formed on one surface of the current collectors 30 on the top surface of the top lithium plate 20d and the bottom surface of the bottom lithium plate 20d is stacked on the top and bottom of the laminated structure, respectively.

Although not shown, an energy storage device according to another exemplary embodiment of the present invention will be described.

The energy storage device according to the exemplary embodiment of the present invention is configured to include the carbonaceous negative electrode (anode) uniformly lithiated according to the exemplary embodiment of the above-mentioned method for lithiation of an electrode, a porous carbonaceous positive electrode (cathode) reversibly inputting and discharging the lithium ions, a separator separating the negative electrode (anode) and the positive electrode (cathode), and an organic electrolyte electrochemically communicating with the negative electrode (anode) and the positive electrode (cathode).

In addition, preferably, the energy storage device according to the exemplary embodiment of the present invention is an energy storage device that performs charging and discharging by electrochemically communicating with the lithium ions. For example, the energy storage device is the lithium ion capacitor.

As set forth above, the exemplary embodiment of the present invention can improve the uniformity and rate of the pre-lithiation of the energy storage device, in particular, the electrode used for the lithium ion capacitor, preferably, the carbon anode electrode.

That is, the exemplary embodiment of the present invention can achieve the rapid and uniform lithiation process through the lithium plate having the special structure satisfying conditions in which first, the plurality of uniformly distributed contact points are provided between the carbon and the lithium metal and second, the electrolytic solution (electrolyte) easily accesses the area around the contact points and the method for lithiation of an electrode using the lithium plate.

In addition, the exemplary embodiment of the present invention can secure the energy storage device having the high efficiency obtained through the uniform lithiation.

It is obvious that various effects directly stated according to various exemplary embodiment of the present invention may be derived by those skilled in the art from various configurations according to the exemplary embodiments of the present invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A lithium plate used for lithium pre-doping of an electrode for an energy storage device, comprising:
a contact area contacting the electrode at the time of the pre-doping; and
a plurality of through holes regularly distributed to be adjacent to the contact area so that an electrolytic solution gains easy access to the vicinity of a contact boundary of the contact area and the electrode at the time of the pre-doping.

2. The lithium plate according to claim 1, wherein a ratio of a width of the contact area between two through holes to a width of the through hole is in a range of approximately 0.5 to 2.0.

3. The lithium plate according to claim 1, wherein the through holes have a circular shape or a regular polygonal shape.

4. The lithium plate according to claim 1, wherein the width of the through hole is in a range of approximately 10 to 10,000 μm.

5. The lithium plate according to claim 1, wherein the lithium plate is reused for the pre-doping.

6. A lithium plate used for lithium pre-doping of an electrode for an energy storage device, comprising:
a plurality of contact areas contacting the electrode at the time of the pre-doping; and
a plurality of grooves regularly distributed to be adjacent to the contact area so that an electrolytic solution gains easy access to the vicinity of contact boundaries of the contact areas and the electrode at the time of the pre-doping.

7. The lithium plate according to claim 6, wherein the plurality of grooves are arranged in a 1-direction.

8. The lithium plate according to claim 6, wherein the plurality of grooves are arranged in a 2-direction so as to cross each other, and the plurality of contact areas are island areas formed by the plurality of grooves.

9. The lithium plate according to claim 6, wherein a top surface and a bottom surface of the lithium plate are provided with the plurality of grooves and the plurality of contact areas.

10. The lithium plate according to claim 6, wherein a ratio of a width of the contact area between the grooves to a width of the groove is in a range of approximately 0.5 to 2.0.

11. The lithium plate according to claim 6, wherein a cross section of the groove is a ‘U’-letter shape, a rectangular shape, a triangular shape, or a trapezoidal shape.

12. The lithium plate according to claim 6, wherein a top width of the groove is in a range of approximately 10 to 10,000 μm.

13. The lithium plate according to claim 6, wherein the lithium plate is reused for the pre-doping.

14. A method for lithiation of an electrode for an energy storage device, comprising:
preparing the lithium plate according to claim 1;
stacking the lithium plate on an electrode material layer formed on a current collector; and
immersing the stacked structure in an electrolyte and pre-doping lithium ions on the electrode material layer.

15. The method according to claim 14, wherein the energy storage device is a lithium ion capacitor.

16. The method according to claim 14, wherein the electrode is a negative electrode (anode).

17. The method according to claim 14, wherein the electrode material layer formed on the current collector is formed by coating and drying a mixing slurry of an active material, conductive additives, and a binder on the current collector, and
at the stacking of the lithium plate, the lithium plate is stacked on the electrode material layer by being compressed.

18. The method according to claim 17 wherein the active material is carbon.

19. The method according to claim 14, wherein the electrolyte is an aprotic organic electrolyte including a lithium salt.

20. The method according to claim 14, wherein the electrode material layer is a carbonaceous electrode layer, and
at the pre-doping, an amount of the pre-doped lithium is in a range of approximately 0.05 to 1 of a weight of the carbonaceous electrode.

21. The method according to claim 14, wherein at the preparing of the lithium plate, a plurality of lithium plates in which both surfaces of the top and bottom thereof are provided with the plurality of grooves and the plurality of contact areas are prepared, and
at the stacking of the lithium plate, a laminated structure is formed by stacking the plurality of electrode material structures between the plurality of lithium plates, wherein the electrode material structure has the electrode material layers formed on both surfaces of the top and bottom of the current collector.

22. A method for lithiation of an electrode for an energy storage device, comprising:
preparing the lithium plate according to claim 6;
stacking the lithium plate on an electrode material layer formed on a current collector; and
immersing the stacked structure in an electrolyte and pre-doping lithium ions on the electrode material layer.

23. The method according to claim 22, wherein the electrode material layer is a carbonaceous electrode layer, and
at the pre-doping, an amount of the pre-doped lithium is in a range of approximately 0.05 to 1 of a weight of the carbonaceous electrode.

24. The method according to claim 22, wherein at the preparing of the lithium plate, a plurality of lithium plates in which both surfaces of the top and bottom thereof are provided with the plurality of grooves and the plurality of contact areas are prepared, and
at the stacking of the lithium plate, a laminated structure is formed by stacking the plurality of electrode material structures between the plurality of lithium plates, wherein the electrode material structure has the electrode material layers formed on both surfaces of the top and bottom of the current collector.

25. An energy storage device, comprising:
the carbonaceous negative electrode (anode) uniformly lithiated according to claim 14;
a porous carbonaceous positive electrode (cathode) reversibly inputting and discharging lithium ions;
a separator separating the negative electrode and the positive electrode; and
an organic electrolyte electrochemically communicating with the negative electrode and the positive electrode.

26. The energy storage device according to claim 25, wherein the energy storage device is a lithium ion capacitor.

27. An energy storage device, comprising:
the carbonaceous negative electrode (anode) uniformly lithiated according to claim 22;
a porous carbonaceous positive electrode (cathode) reversibly inputting and discharging lithium ions;
a separator separating the negative electrode and the positive electrode; and
an organic electrolyte electrochemically communicating with the negative electrode and the positive electrode.

28. The energy storage device according to claim 27, wherein the energy storage device is a lithium ion capacitor.
